(19) United States
(12) Patent Application Publication
(10) Pub. No.: US 2006/0278734 A1
(43) Pub. Date: Dec. 14, 2006

(54) Jet shower apparatus for providing jets of fluid

(75) Inventor: Shuji Morishita, Osaka (JP)

Correspondence Address: NDQ&M WATCHSTONE LLP, 1300 EYE STREET, NW, 400 EAST TOWER, WASHINGTON, DC, 20005, US

(73) Assignee: EC Techno, Inc.

(21) Appl. No.: 11/335,570

(22) Filed: Jan. 20, 2006

(30) Foreign Application Priority Data
Jun. 13, 2005 (JP) 2005-17161

(51) Int. Cl. B05B 7/08

(52) U.S. Cl. 239/426; 239/428.5; 239/558

(57) ABSTRACT

A jet shower apparatus for providing a shower of bubble-filled fluid which is arranged for mixing a fluid to be sprayed with bubbles of air or any gaseous material in order to improve the effect of activation.

A fluid spraying apparatus which has a number of annular spray members 11 arranged different in the diameter and disposed coaxially, each annular spray member 11 having spray channels 17 provided therein extending to spray outlets 12 at the upper end, each spray channel 17 of a two-step configuration consisting mainly of a large diameter region 17L at the spray outlet 12 side and a small diameter region 17S at the water inlet side, is characterized by:

a group of gas intaking apertures provided communicating with a lower area close to the small diameter region 17S of the large diameter region 17L for intaking air at the side.

### FIELD OF THE INVENTION

The present invention relates to a jet shower apparatus for providing a shower of bubble-filled fluid which is arranged for mixing a fluid to be sprayed with bubbles of air or any gaseous material in order to improve the effect of activation.

Fluids to be sprayed include not only water from the existing water supply system but also cooling machine oil in the machining process, cleaning or rinsing water for use in industrial machines, industrial cleaners, and household washing machines, various liquids, fluid materials conveyable in conduits, e.g., fine powder, liquefied materials added with liquid or powder, and food materials in fine powder form.

### DESCRIPTION OF RELATED ART

One of such fluid spraying apparatuses is disclosed in Japanese Patent Laid-open Publication No. 2000-325251 titled as shower head arranged for mixing water with gas thus to improve the water saving and the water strength at the spray outlet thereof.

### SUMMARY OF THE INVENTION

The above mentioned prior art has however a drawback that the strength of water at the spray head is too high to produce a uniform spray.

It is an object of the first invention to produce a uniform spray of water from the entire region of the spray head.

It is an object of the second invention to produce an intensified spray of water selectively from a desired region of the spray head.

The device of the known art has gas intaking apertures provided for communicating with a single annular channel. While this device is intended to mix water to be sprayed with gas, it fails to produce different sizes of bubbles or mix with different types of gaseous material.

It is an object of the third invention to mix a fluid to be sprayed with different types of bubbles (different in the size and the gaseous material).

It is an object of the fourth invention to mix a fluid (such as supply water, waste water, powder fluid) with liquid or powder material as well as gaseous bubbles.

As a first invention, a fluid spraying apparatus (for producing a shower of bubble-filled fluid), which has a number of annular spray members 11 arranged different in the diameter and disposed coaxially, each annular spray member 11 having spray channels 17 provided therein extending to spray outlets 12 at the upper end, each spray channel 17 of a two-step configuration consisting mainly of a large diameter region 17L at the spray outlet 12 side and a small diameter region 17S at the water inlet side, is characterized by:

a group of gas intaking apertures provided communicating with a lower area close to the small diameter region 17S of the large diameter region 17L for intaking air at the side.

As a second invention, the fluid spraying apparatus (for producing a shower of bubble-filled fluid) of the first feature may be modified in which the interior space defined by the annular spray members 11 is separated into an annular chamber 3A and a center chamber 3B while a discharge selector plate 21 is provided having a first discharge outlet 25 communicated to the center chamber 3B and a second discharge outlet 26 communicated to the annular chamber 3A, whereby the discharge selector plate 21 is selectively slid between the first discharge outlet 25 communicated to the center chamber 3B and the second discharge outlet 26 communicated to the annular chamber 3A for conducting an opening and closing action.

As a third invention, a fluid spraying apparatus (for producing a shower of bubble-filled fluid), which includes a shower head arranged at the distal end and having an internal space provided therein for communicating with a water supply passage and a group of spray outlets provided therein for producing a shower of water, the shower head comprising a set of spray members installed in a head case, each spray member having a group of vertically extending water supply channels 17 which are disposed in a concentric relationship to communicate between the spray outlets at the upper end and the internal space at the lower end, is characterized in that each of the spray channels 17 is arranged of a two-step configuration consisting mainly of a large diameter region 17L at the spray outlet 12 side and a small diameter region 17S at the water inlet side, and

a group of gas intaking apertures provided communicating with a lower area close to the small diameter region 17S of the large diameter region 17L for intaking gas at the side, said gas intaking apertures being separately each other.

As a fourth invention, the fluid spraying apparatus (for producing a shower of bubble-filled fluid) of the third invention may be modified in which at least one of the gas intaking apertures is communicated with a fluid supply source for feeding a liquid or powder material which is different from a gaseous material while the other gas intaking apertures are communicated with a gas supply source.

According to the first invention, a spray or jet of bubble-filled water, liquid, or fluid can be directed towards the body, the floor, the cleaning surface, or the like thus to provide a bubbling effect where the bubbles in the spray are burst, hence stimulating the body skin and improve the cleaning action. The first feature of the present invention allows a uniform spray of water to be produced throughout the entire surface of the spray head.

The second invention allows a spray of water to be intensified selectively at a desired location of the spray head.

The third invention allows the fluid to be sprayed to be mixed with different types of bubbles (in the size and the material), thus improving the bubbling effect where the bubbles are burst particularly for encouraging a processing action with biological processing enzymes in a processing container or a cleaning action with cleansers in a cleansing container.

The fourth invention allows the fluid to be sprayed to be mixed with a liquid or fine power form of material as well as the bubbles of gaseous material, whereby the action of food processing in a food process container or other processing in a process container can be improved with the help of the mixed materials (including additive liquid or powder) as well as the bubbling effect where the bubbles of food process auxiliary agents or biological enzymes are burst.

### BRIEF DESCRIPTION OF THE DRAWINGS

FIG. 1 is a side view of a shower head for a bathroom illustrating the embodiment of the first invention;

FIG. 2 is a longitudinally cross sectional view of the same;

FIG. 3 is a longitudinally cross sectional view of a spray device of the embodiment of the first invention;

FIG. 4 is a front view of the same;

FIGS. 5(a) and (b) are a longitudinally cross sectional view and a plan view respectively of a first step annular spray member;

FIGS. 6(a) and (b) are a longitudinally cross sectional view and a plan view respectively of a second step annular spray member;

FIGS. 7(a) and (b) are a longitudinally cross sectional view and a plan view respectively of a third step annular spray member;

FIGS. 8(a) and (b) are a longitudinally cross sectional view and a plan view respectively of a base;

FIGS. 9(a) and (b) are a longitudinally cross sectional view and a plan view respectively of a ring support;

FIG. 10 is a longitudinally cross sectional view showing a primary part of the spray device;

FIG. 11 is a side view of a shower head for a bathroom illustrating the second embodiment of the present invention;

FIG. 12 is a longitudinally cross sectional view of a primary part of the same;

FIG. 13 is a longitudinally cross sectional view of a discharge selector plate;

FIG. 14 is a plan view of the same;

FIG. 15 is a bottom view of the spray device of the embodiment of the second invention where the first discharge outlet in its valve is opened to the annular chamber;

FIG. 16 is a longitudinally cross sectional view of the same;

FIG. 17 is a bottom view of the spray device of the second invention where the second discharge outlet in its valve is opened to the center chamber;

FIG. 18 is a longitudinally cross sectional view of the ring support;

FIG. 19 is a plan view of a spray device showing another embodiment of the second invention;

FIGS. 20(a) to (e) are longitudinally cross sectional views showing various forms of the spray outlet;

FIGS. 21(a) to (c) illustrate a straight pattern, a dispersing pattern, and a concentrating pattern respectively of the spray of water from the spray outlets;

FIG. 22 is a perspective view of a cleaning nozzle according to the first invention and the second invention;

FIG. 23 is a front view of a spraying apparatus (a jet shower apparatus) illustrating the embodiment of the third invention;

FIG. 24 is a longitudinally cross sectional view of the same;

FIG. 25 is a plan view of the same;

FIG. 26 is a front view of a modification of the spraying apparatus (a jet shower apparatus) of the third embodiment of the present invention;

FIG. 27 is a longitudinally cross sectional view of the same;

FIG. 28 is a plan view of the same;

FIG. 29 is a plan view of a water spraying body;

FIG. 30 is a longitudinally cross sectional view of the same; and

FIG. 31 is an explanatory view of a controlling mechanism for timing the generation of bubbles.

### DETAILED DESCRIPTION OF THE PREFERRED EMBODIMENTS

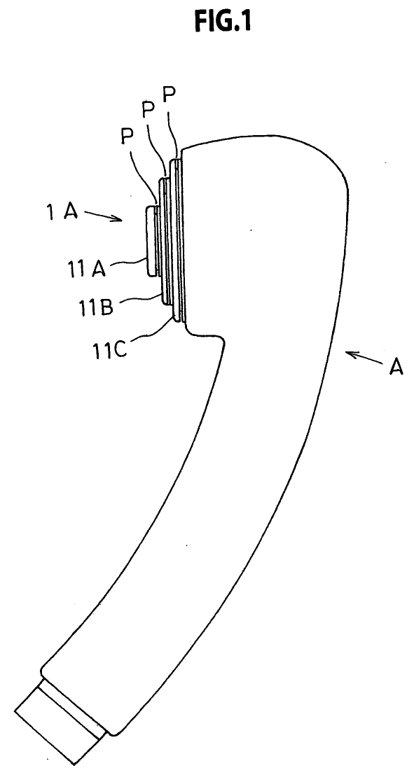

The embodiment of the first invention will be described referring to FIGS. 1 to 10.

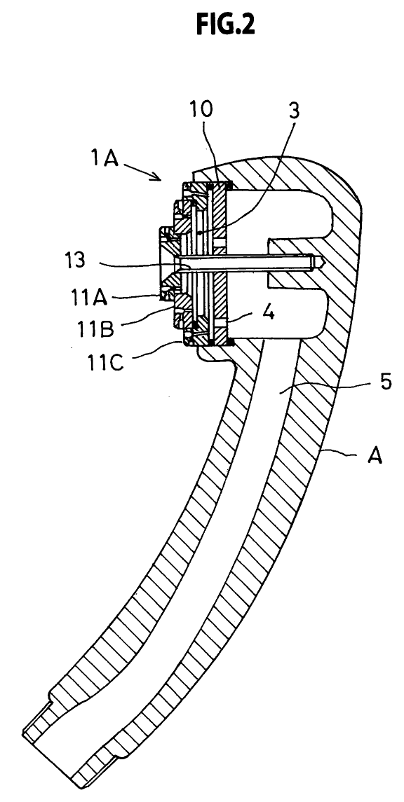

FIG. 1 illustrates a side view of a shower head A for a bathroom equipped with a spray device 1A of the first embodiment and FIG. 2 is a longitudinally cross sectional view of the same.

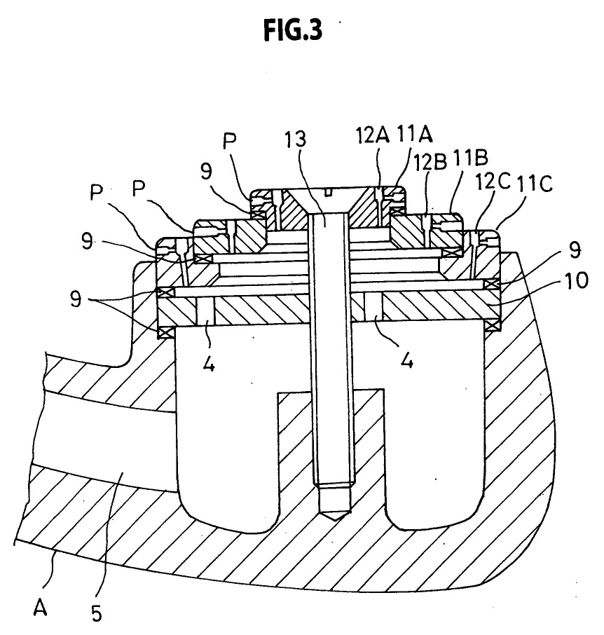

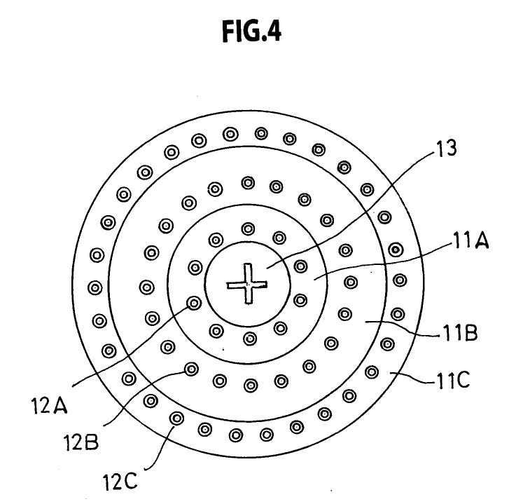

FIGS. 3 and 4 illustrate the spray device 1A which comprises a first step annular spray member 11A, a second step annular spray member 11B, and a third step annular spray member 11C disposed coaxially and having spray outlets 12A, 12B, and 12C provided in the same sides thereof respectively. Each group of the spray outlets 12A, 12B, and 12C is arranged in a concentric relationship as shown in FIG. 4.

While the three annular spray members 11A, 11B, and 11C are assembled together and tightened to a base 10 by a screw 13 extending across the center to develop a stepped form of the spray device 1, the first step annular spray member 11A arranged close to the center is disposed at the uppermost step of the stepped form and embedded partially in the lower step.

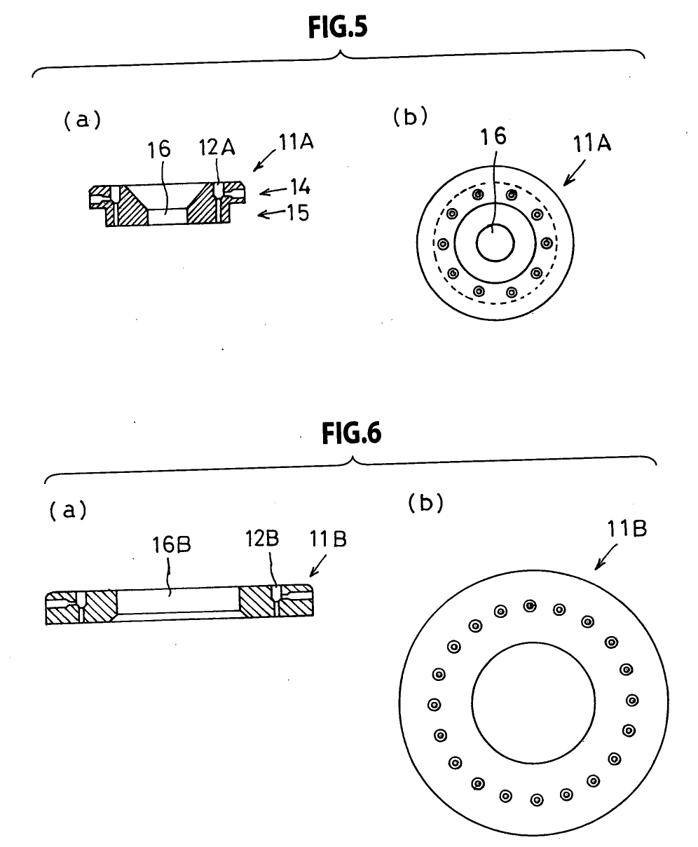

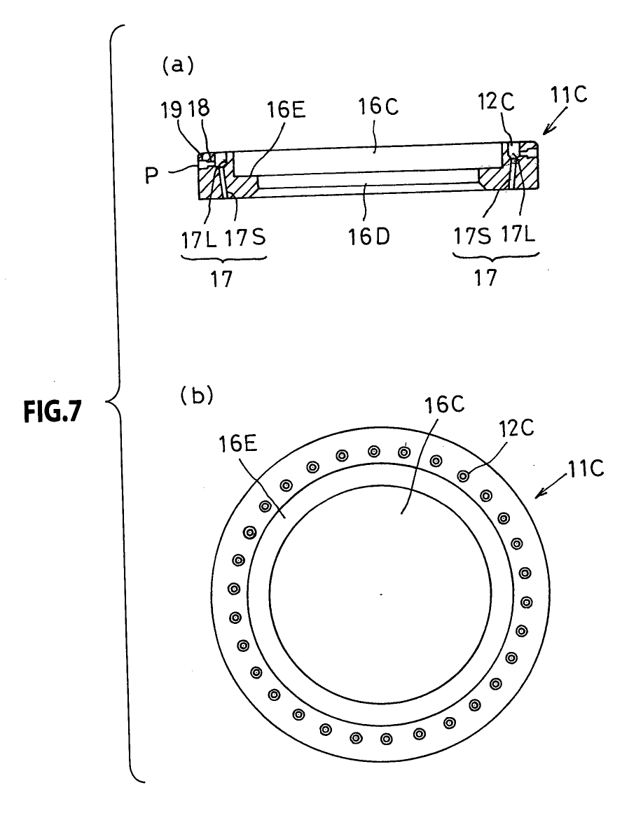

FIGS. 5(a) and (b) illustrate the first step annular spray member 11A, FIGS. 6(a) and (b) illustrate the second step annular spray member 11B, and FIGS. 7(a) and (b) illustrate the third step annular spray member 11C.

The following describes each of the annular spray members 11.

The first step annular spray member 11A has a center hole 16A provided in the center thereof through which the screw 13 extends and its upper half denoted by 14 is arranged of a flange shape projecting laterally more than its lower half denoted by 15.

The second step annular spray member 11B has a center opening 16B provided in the center thereof for accepting the lower half 15 of the first step annular spray member 11A.

The third step annular spray member 11C has a center opening 16C provided in the center thereof for accepting the lower half of the second step annular spray member 11B and a step portion 16E provided at the rim thereof. The center opening 16C is communicated with a center hole 16D.

As the first step annular spray member 11A, the second step annular spray member 11B, and the third step annular spray member 11C are assembled coaxially, each of their spray outlets 12A, 12B, and 12C, each group allocated in a ring, is communicated with a water supply channel 17. The water supply channel 17 consists mainly of a large diameter region 17L communicated with the spray outlet 12 and a small diameter region 17S communicated with a water source conduit.

The water supply channel 17 is also communicated via a vent, which is a combination of a side small aperture 18 and a side ring channel 19 as communicating from a lower area close to the small diameter region 17S of the large diameter region 17L, to an aperture p provided in the side of each annular spray member 11 for opening to the atmosphere.

As shown in FIGS. 1 and 2, the side ring channels 19 extend to the outer edges of the annular spray members 11A, 11B, and 11C (the circumference of the spray device 1).

Referring to FIG. 3, as the three center openings 16B, 16C, and 16D incorporate an interior space 3 provided in the spray device 1, the water supply channels 17 are enlarged at the lower end (the inlet side) for ease of intaking the water from the interior space 3 while preventing any leakage.

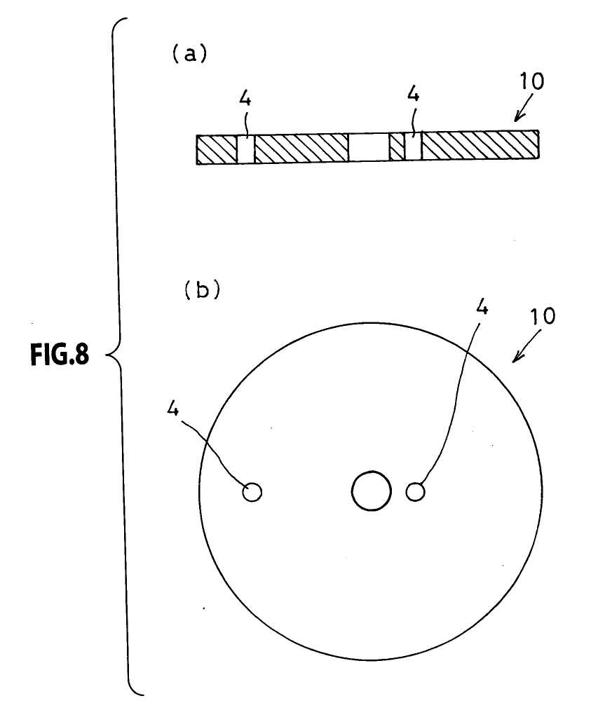

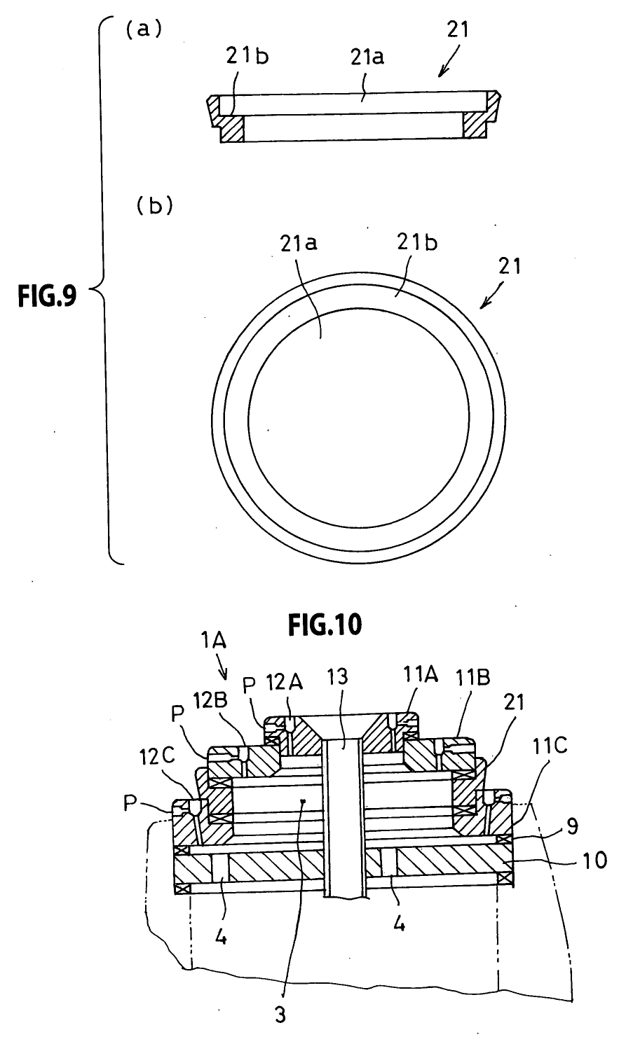

As shown in FIGS. 9(a) and (b), an outer ring support 21 having a center opening 21a provide therein and a step 21b formed at the rim thereof is inserted between the second step annular spray member 11B and the third step annular spray member 11C, thus increasing the size of the interior space 3.

The interior space 3 is communicated across water supply holes 4 provided in a base 10 to a water supply passage 5 provided in the shower head as shown in FIGS. 8 and 10.

Although a group of the water supply channels 17 are provided in a ring in the annular spray member 11 of the embodiment, one of the water supply channels 17 may be provided in each member 11 as shown in FIG. 19.

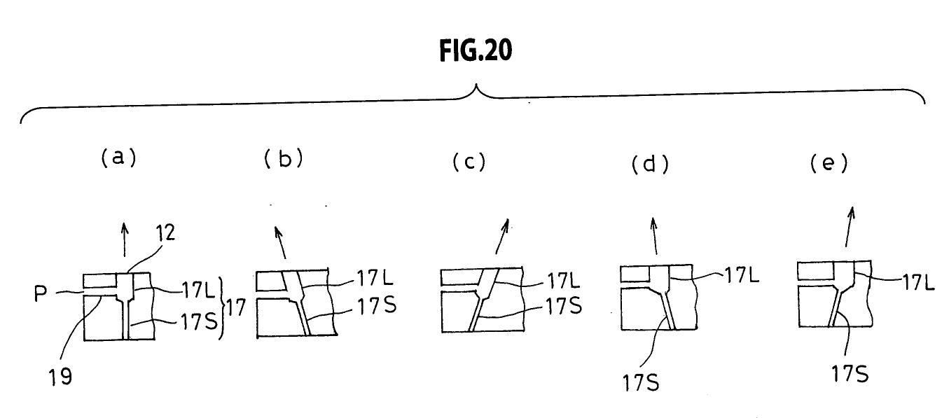

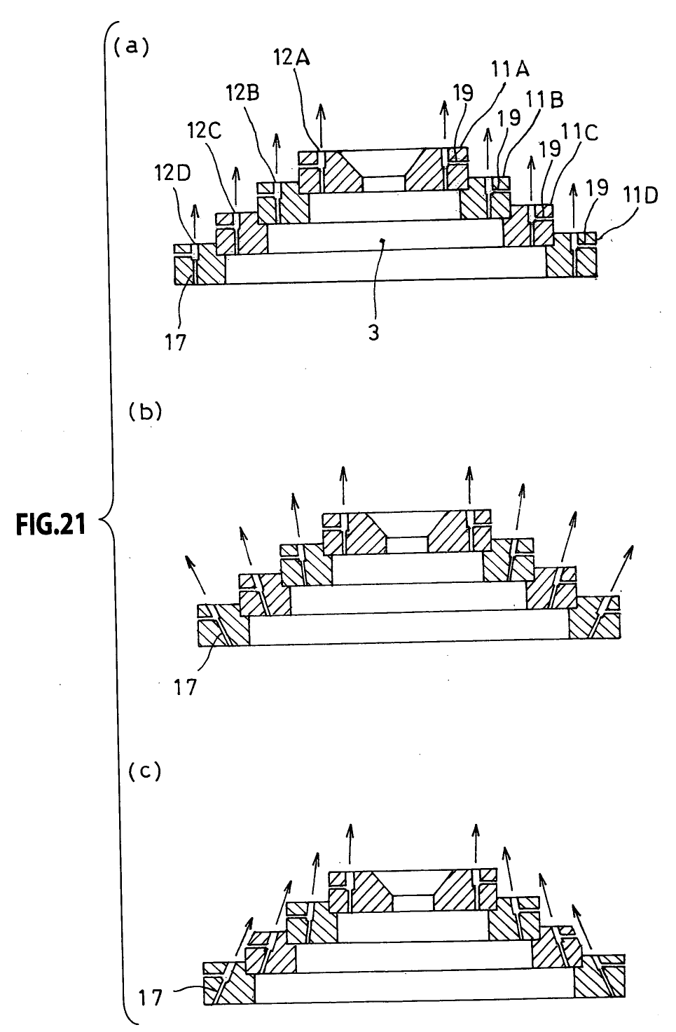

Alternatively, the water supply channels 17 in the spray device 1 as shown in FIGS. 5-7 may be tilted towards the outer side or the center as shown in FIGS. 20(b) to (e) and FIGS. 21(b) and (c).

The water spray channel 17 in the spray device 1 is arranged with its large diameter region 17L extending vertically and its small diameter region 17S extending slantly as shown in FIGS. 20(b) to (e) and FIGS. 21(b) and (c) but not intended to be so limited. For example, when both the large diameter region 17L and the small diameter region 17S extend vertically, they can easily be bored by a machining process.

The embodiment of the second invention will now be described referring to FIGS. 11 to 18.

FIG. 11 is a side view of a shower head B for a bathroom equipped with a spray device 1B of the second embodiment where the shower head A in the first embodiment is modified with a selector button switch 6.

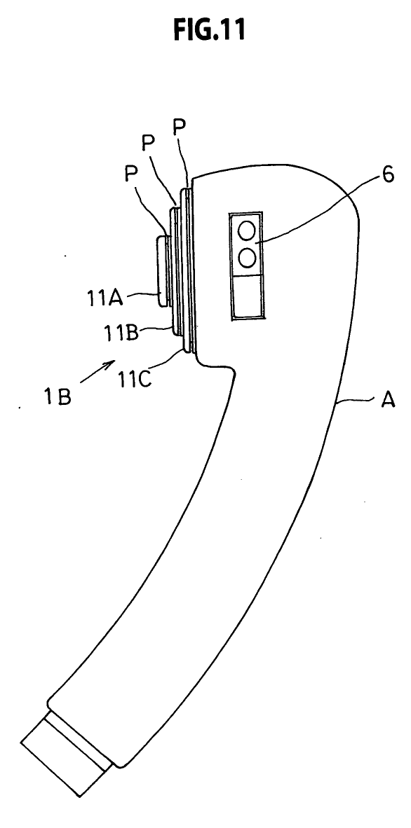

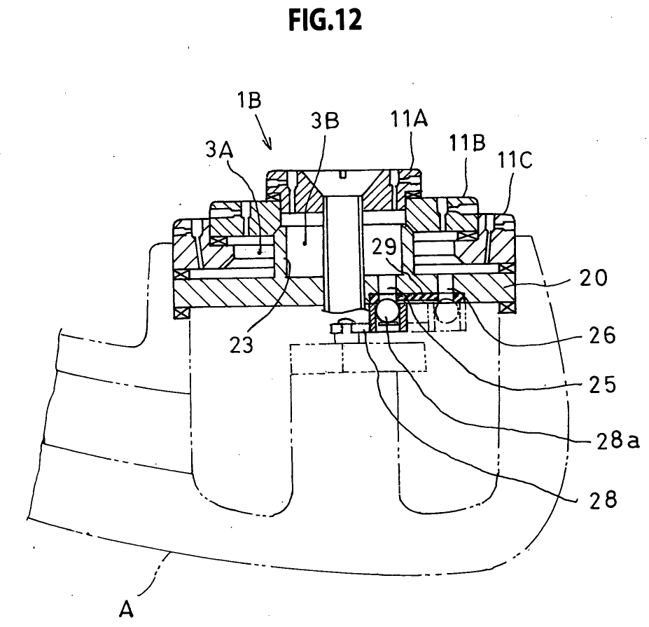

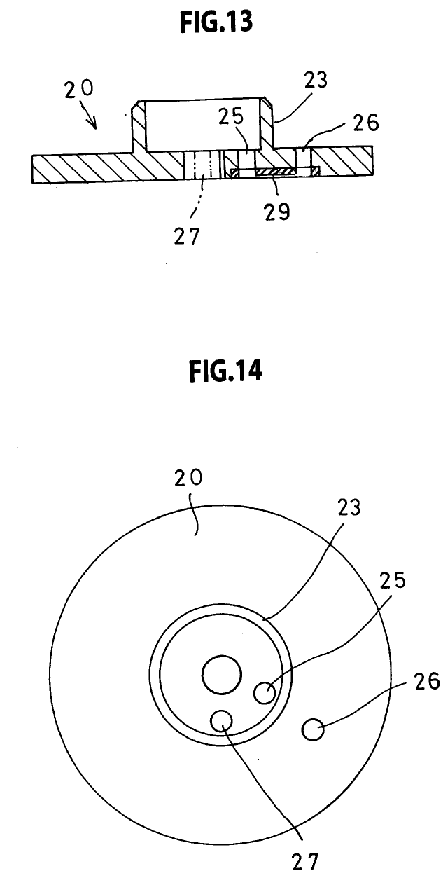

As shown in FIGS. 12 and 13, the spray device 1B comprises a first step annular spray member 11A, a second step annular spray member 11B, a third step annular spray member 11C similar to those of the spray device 1A of the first embodiment, and a discharge selector plate 20 which replaces the base 10.

The discharge selector plate 20 has a tubular wall portion 23 provided at the upper thereof separating the internal chamber into an annular chamber 3A and a center chamber 3B (See FIG. 13), as shown in FIGS. 14 and 15. The discharge selector plate 20 also has a screw hole 24 provided in the center thereof for accepting a retaining screw, a first discharge outlet 25 provided therein for communicating with the center chamber 3B, and a second discharge outlet 26 provided therein for communicating with the annular apace 3A. A third discharge outlet 27 may be added for constantly discharging the abundance of water with no use of a switching valve.

As shown in FIG. 13, a switching valve mechanism 28 is provided for selectively conducting an opening and closing action between the first and second discharge outlets 25 and 26.

The switching valve mechanism 28 is arranged for sliding over a guide-grooved packing 29 a (ball) valve 28a of a driving strip 28 actuated by the selector button switch 6 between the first discharge outlet 25 and the second discharge output 26 for selectively conducting the opening and closing action.

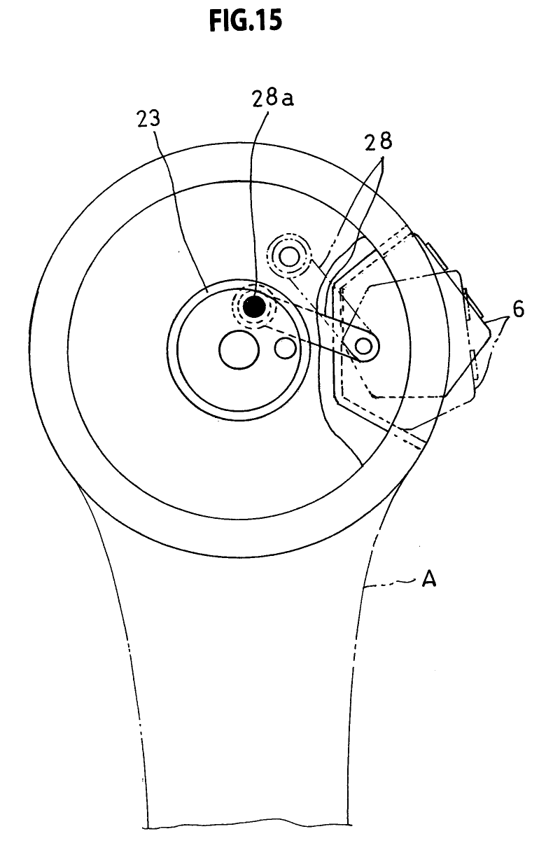

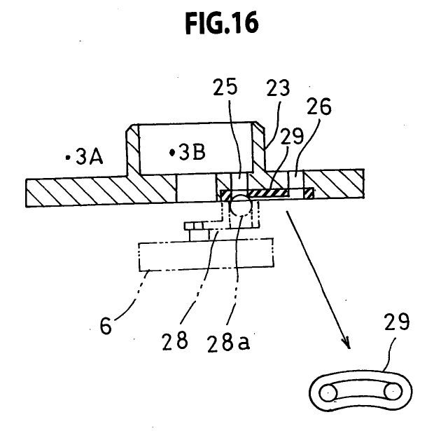

FIGS. 15 and 16 illustrate an action of the valve where the first discharge outlet 25 is opened and the second discharge outlet 26 is closed.

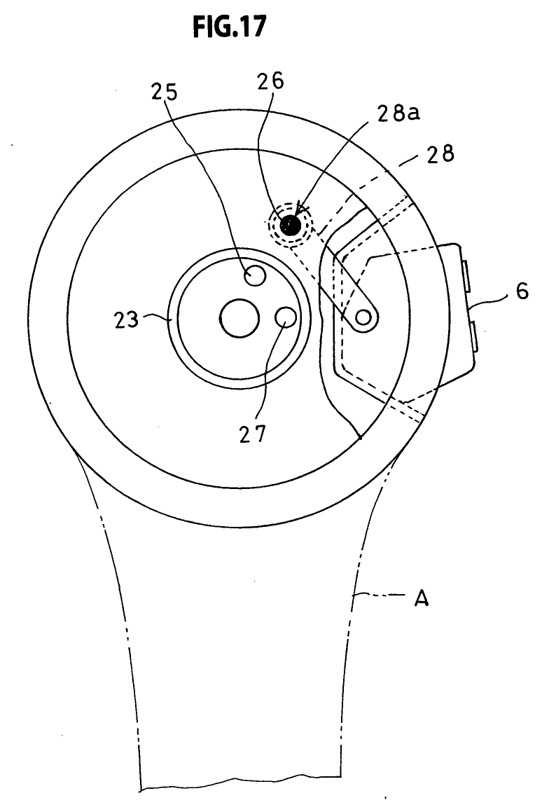

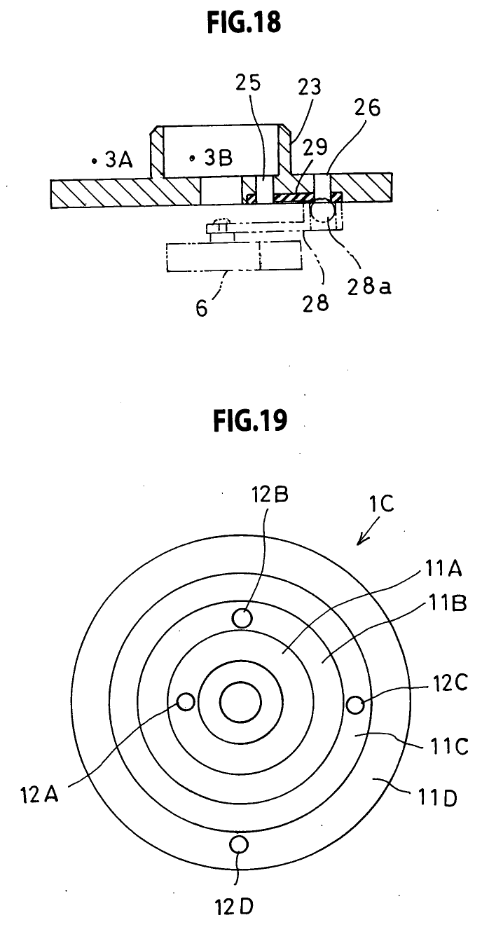

FIGS. 17 and 18 illustrate another action of the valve where the first discharge outlet 25 is closed and the second discharge outlet 26 is opened.

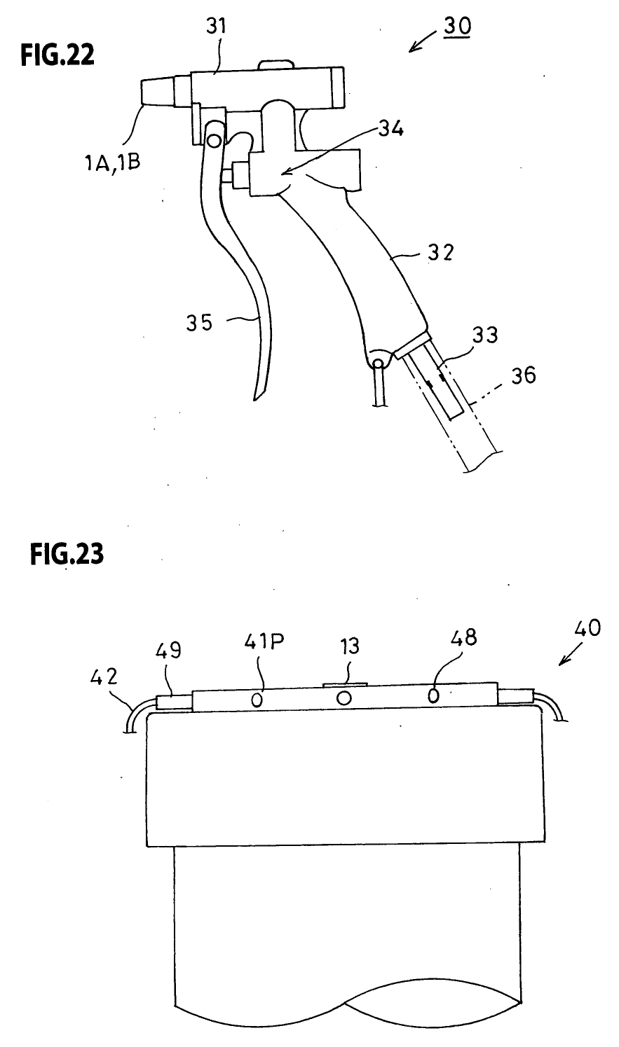

FIG. 22 illustrate a cleaning nozzle 30 equipped at its distal end with the spaying apparatus 1A or 1B for cleaning a vehicle, a wall, a road surface, etc.

The cleaning nozzle 30 comprises a nozzle head 31 in which the spraying apparatus 1A or 1B is installed, a nozzle body 32 acting as a grip, a hose connect 33 extending outwardly from the nozzle body 32, and a valve mechanism 34 mounted between the nozzle head 31 and the nozzle body 31. When the valve mechanism 34 is opened by a user pulling its lever 35 towards the nozzle body 32, the nozzle head 31 is communicated by the nozzle head 31 to a hose 36 for releasing a jet of cleaning water from the nozzle head 31.

When a jet of the cleaning water filled with bubbles strikes against the target to be cleaned down such as a vehicle, a wall, or a road surface, its bubbles are burst to stimulate the cleaning action.

Equally, with the nozzle head having the spraying apparatus 1A or 1B installed therein and fixedly coupled to a faucet or shower outlet on the wall of a bathroom, the body of a user can be cleaned down and stimulated by the bursting action of the bubbles in a shower of water thus significantly encouraging the health care.

The materials of the components are stainless steel, brass, gun metal, and other metals or various industrial resin materials but not intended to be so limited.

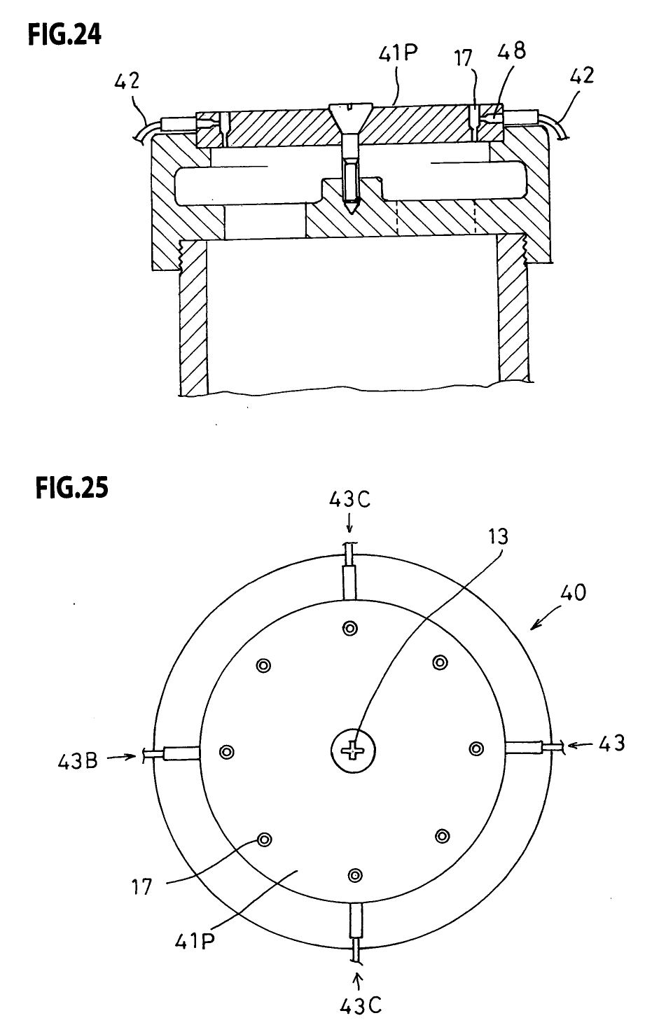

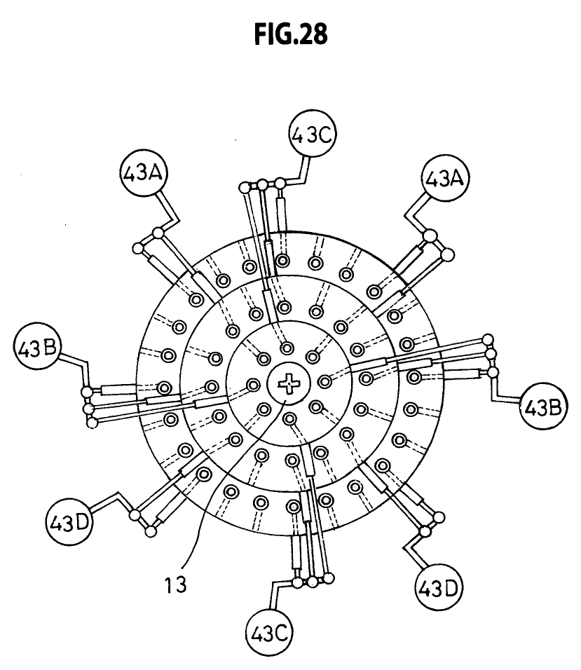

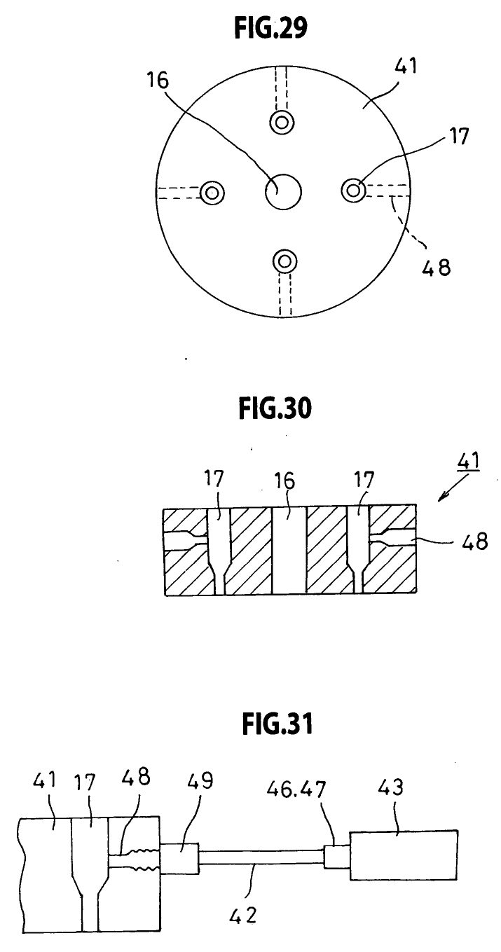

The embodiment of the third invention will be described referring to FIGS. 23 to 31.

As the embodiment of the third invention, a spraying head is provided comprising a spray member, which has a group of spray channels 17 concentrically provided therein to extend vertically and communicate at the upper end to the spray outlets and at the lower end to the interior space, and a head case in which the spray member is installed.

Similar to the spray members of the first embodiment, each of the spray channels 17 has a two-step configuration consisting mainly of a large diameter region 17L at the spray outlet 12 side and a small diameter region 17S at the water inlet side.

As shown in FIGS. 23 to 25, the spray member 41P of the jet shower head 40 of the third embodiment has a group of gas intaking apertures 48A, 48B, 48C, 48D, . . . provided communicating with a lower area close to the small diameter region 17S of the large diameter region 17L for intaking air at the side, in which said gas intaking apertures are separately each other.

The spray member 41P has a center hole 16 provided in the center thereof through which a screw 13 extends.

The gas intaking apertures 48A, 48B, 48C, 48D . . . may be communicated partially with mixture supply hoses 42 which are in turn connected with a mixture supply source (for example, a perfume contained gas container 43B) for selectively providing different types and/or sizes of bubbles.

For example, the gas intaking apertures 48A and 48C remain open to the atmosphere but not connected to the mixture supply hoses 42 while the gas intaking aperture 48B is communicated with the perfume contained gas mixture supply source 43B. In addition, the gas intaking aperture 48D is communicated with a cleanser contained mixture supply source 43B. This can fill the bathroom with an atmosphere of mental ease. Moreover, the spray member may be connected with an ozone generator in addition to the perfume contained mixture supply source 43B and the cleanser contained mixture supply source 43B.

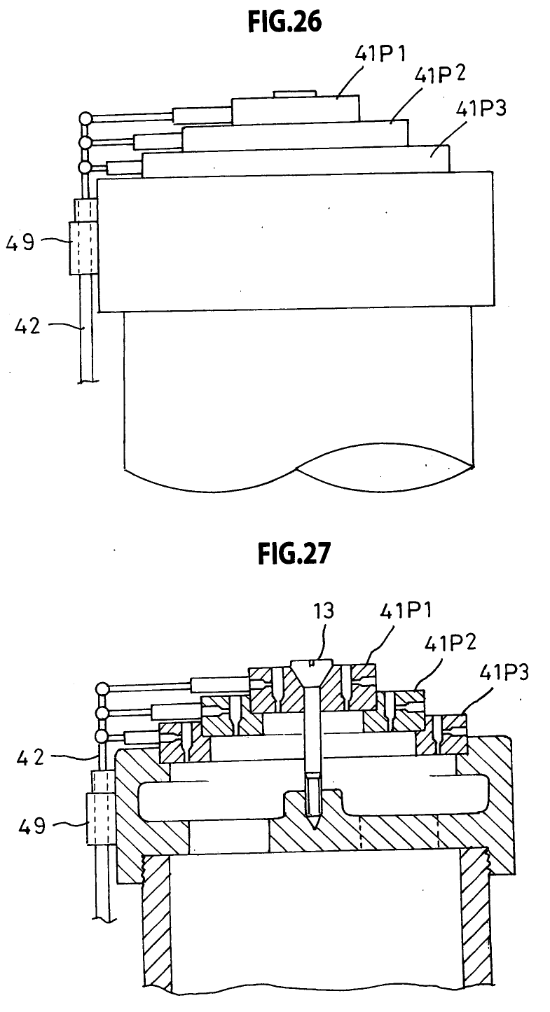

Although the jet shower apparatus 40 includes the single spray member 41P shown in FIGS. 23 to 25, it may be provided with a plurality of annular plate-like spray members 41p1, 41p2, 41p3, . . . arranged concentrically as shown in FIGS. 26 and 27 similar to those of the first embodiment.

Alternatively, when the gas intaking apertures 48A, 48B, 48C, . . . are modified to have different diameters, they can provide different sizes of bubbles (of air) with no connection of the mixture supply hoses 42.

Also, when the gas mixture supply sources 43B are connected with a valve mechanism which can be controlled by a controller or a computer, they can selectively supply a desired type(s) of gas bubbles at the desired timing and for a desired length of time.

Furthermore, as shown in FIG. 31, an intermittent action constant-amount feeding mechanism 46 (for feeding a constant amount, e.g., 5 ml, at equal intervals of time) or an intermittent solenoid valve 47 (for opening, for example, 3 seconds at intervals of 5 seconds) may be connected by front or rear joints 49 to the mixture supply hoses 42 or the mixture supply source 43, which acts as the controller.

The embodiment of the third invention may be modified as the embodiment of the fourth invention where at least one of the gas intaking apertures is communicated to a fluid supply source 43B (as shown in FIG. 25) for feeding not a gaseous material but a liquid or fluid (e.g., cleaning water, biochemical processing enzyme, or food processing adder) while the others remaining communicated to a gas supply source 43C (as shown in FIG. 25).

This allows the apparatus to provide a spray of the fluid filled with bubbles such as cutting oil for machining, waste water from a sewage system, or flour powder with equal success.

1. A fluid spraying apparatus, which has a number of annular spray members arranged different in the diameter and disposed coaxially, each annular spray member having spray channels provided therein extending to spray outlets at the upper end, each spray channel of a two-step configuration consisting mainly of a large diameter region at the spray outlet side and a small diameter region at the water inlet side, is characterized by:
a group of gas intaking apertures provided communicating with a lower area close to the small diameter region of the large diameter region for intaking air at the side.

2. A fluid spraying apparatus, which has a number of annular spray members arranged different in the diameter and disposed coaxially, each annular spray member having spray channels provided therein extending to spray outlets at the upper end, each spray channel of a two-step configuration consisting mainly of a large diameter region at the spray outlet side and a small diameter region at the water inlet side, is characterized by:
a group of gas intaking apertures provided communicating with a lower area close to the small diameter region of the large diameter region for intaking air at the side, and
the interior space defined by the annular spray members is separated into an annular chamber and a center chamber 3B while a discharge selector plate is provided having a first discharge outlet communicated to the center chamber and a second discharge outlet communicated to the annular chamber, whereby the discharge selector plate is selectively slid between the first discharge outlet communicated to the center chamber and the second discharge outlet communicated to the annular chamber for conducting an opening and closing action.

3. A fluid spraying apparatus, which includes a shower head arranged at the distal end and having an internal space provided therein for communicating with a water supply passage and a group of spray outlets provided therein for producing a shower of water, the shower head comprising a set of spray members installed in a head case, each spray member having a group of vertically extending water supply channels which are disposed in a concentric relationship to communicate between the spray outlets at the upper end and the internal space at the lower end, characterized in that
each of the spray channels is arranged of a two-step configuration consisting mainly of a large diameter region at the spray outlet side and a small diameter region at the water inlet side, and
a group of gas intaking apertures provided communicating with a lower area close to the small diameter region of the large diameter region for intaking gas at the side, said gas intaking apertures being separately each other.

4. A fluid spraying apparatus, which includes a shower head arranged at the distal end and having an internal space provided therein for communicating with a water supply passage and a group of spray outlets provided therein for producing a shower of water, the shower head comprising a set of spray members installed in a head case, each spray member having a group of vertically extending water supply channels which are disposed in a concentric relationship to communicate between the spray outlets at the upper end and the internal space at the lower end, characterized in that
each of the spray channels is arranged of a two-step configuration consisting mainly of a large diameter region at the spray outlet side and a small diameter region at the water inlet side,
a group of gas intaking apertures provided communicating with a lower area close to the small diameter region of the large diameter region for intaking gas at the side, and
at least one of the gas intaking apertures is communicated with a fluid supply source for feeding a liquid or powder material which is different from a gaseous material while the other gas intaking apertures are communicated with a gas supply source.
